(19) United States
(12) Patent Application Publication
(10) Pub. No.: US 2006/0111827 A1
(43) Pub. Date: May 25, 2006

(54) Accurate velocity dependent audio system

(76) Inventors: Lars Russlies, Hamburg (DE); Joachim Wietzke, Karlsruhe (DE)

Correspondence Address: BRINKS HOFER GILSON & LIONE, P.O. BOX 10395, CHICAGO, IL, 60610, US

(21) Appl. No.: 11/198,012

(22) Filed: Aug. 5, 2005

(30) Foreign Application Priority Data
Aug. 5, 2004 (DE) 10 2004 038 151.8

(51) Int. Cl. E05F 15/00

(52) U.S. Cl. 701/49; 340/426.34

(57) ABSTRACT

A vehicle system includes a navigation module, a memory, and a processor. The navigation module provides a vehicle velocity signal. An audio control program resides in the memory. The processor is programmed to execute the audio control program to adjust an audio parameter in the vehicle system.

### PRIORITY CLAIM

This application claims the benefit of priority from German Patent Application No. 10 2004038 151.8, filed Aug. 5, 2004, which is incorporated herein by reference.

### BACKGROUND OF THE INVENTION

1. Technical Field

This invention relates to velocity dependent audio in a vehicle, and in particular, to a system that controls audio using velocity information.

2. Related Art

The amount of noise within a vehicle may be a function of a vehicle's velocity. The noise heard in a car may vary with environment or structure and may vary with the speed of the vehicle.

At a high speed, a passenger may increase the volume of a radio to compensate for an increase in noise caused by rain, tire hum, wind noise, or engine noise. At slower speeds, a driver may reduce the volume of their radio as the external noise is reduced.

In some vehicles, a driver manually controls the volume as the external noise varies with the vehicle's speed. The volume may also be controlled automatically. Automatic volume control may be safer than a manual control because the driver's attention is not diverted from the road.

Velocity may be measured by counting the number of engine revolutions or tracking tachometer signals. Unfortunately, such measurements may be inaccurate and complicated. Therefore a need exists for a convenient and reliable system for automatically adjusting vehicle volume based on the speed of the vehicle.

### SUMMARY

A vehicle system includes a navigation module, a memory, and a processor. The navigation module provides a vehicle velocity signal. An audio control program resides in the memory. The processor is programmed to execute the audio control program that adjusts an audio parameter in the vehicle system.

A method includes the acts of polling a navigation module, determining a velocity dependent audio parameter, determining an adjustment to an audio parameter, and updating the audio parameter. Polling the navigation module provides a vehicle velocity signal. An audio parameter adjustment may be calculated using the vehicle velocity and the velocity dependent audio parameter. The adjustment may be transmitted to an audio module to be updated.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a vehicle system.

FIG. 2 is a block diagram for adjusting a velocity dependent audio control.

FIG. 3 is a second block diagram for adjusting a velocity dependent audio control.

FIG. 4 is a third block diagram for adjusting a velocity dependent audio control.

FIG. 5 is a flow chart for adjusting an audio parameter.

### DETAILED DESCRIPTION OF THE PREFERRED EMBODIMENTS

Audio and navigation systems may be integrated within luxury and economy vehicles. Some navigation systems provide position and route information. Other navigation systems provide reliable vehicle velocity data that may be used by the audio system. Velocity data may be used to adjust audio parameters to compensate for the noise associated with the movement of a vehicle.

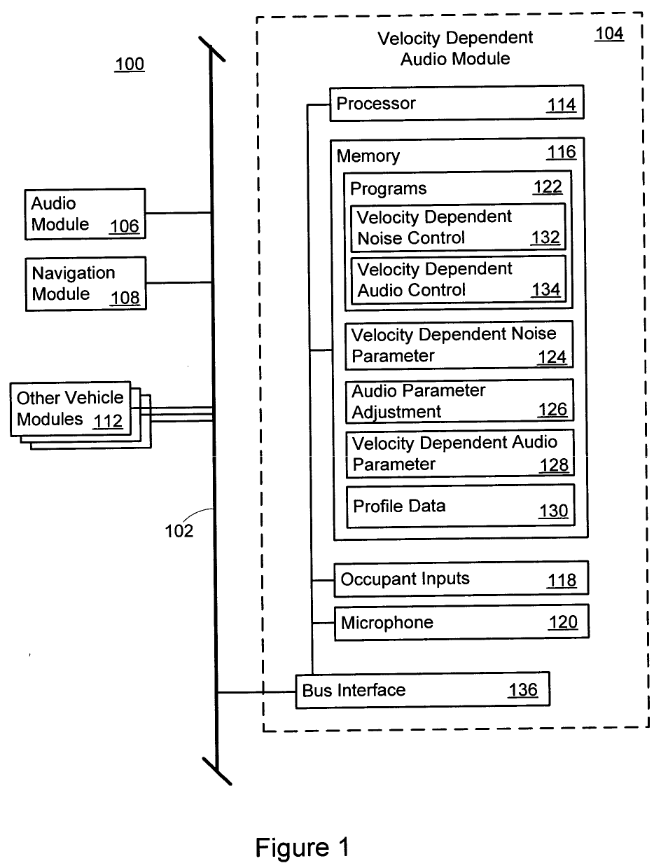

In FIG. 1, vehicle system 100 includes a vehicle communication bus 102, a velocity dependent audio module 104, an audio module 106, a navigation module 108. The electronic system may also include other vehicle modules 112. The vehicle system 100 may also include other systems, sensors, and modules that control and/or manage vehicle performance or improve entertainment and comfort in the vehicle.

The audio module 106 may include devices that convert electric signals into audible sound (e.g., a speaker, a radio, a cassette player, a CD player, a DVD player, devices that communicate audible sound, and/or a voice response system). The audio module 106 may control audio parameters through a user or occupant control or through signals received from other devices. The audio module 106 may control volume, bass, treble, tuning, and other parameters that may be heard or transmitted through a wireless medium.

The navigation module 108 may include a global positioning system (“GPS”). The GPS may interface or include velocity sensors. The navigation module 108 may receive and/or store digital map data and may include or interface motion sensors, such as wheel sensors and gyroscopes. The navigation module 108 may track vehicle position data and may provide instantaneous, momentary, or current vehicle velocity. Some velocity sensors may provide reliable and accurate data about the vehicle's speed. The velocity sensors may be calibrated through the GPS and may use digital map data.

The other vehicle modules 112 may comprise a powertrain module, an anti-lock brake module, transmission module, a lock and window module, a video module, a climate module, a sunroof module, an entertainment and comfort module, and a passenger detection module. Each of these modules may communicate with other modules in the vehicle wirelessly, or through the communication bus 102.

The velocity dependent audio module 104 may provide an audio parameter adjustment 126. The velocity dependent audio module 104 may include a processor 114, memory 116, occupant inputs 118, and a device that detects or converts sound into an electrical signal such as a microphone 120.

The memory 116 may store programs 122 and program data to be processed by the processor 114. The memory 116 may store a velocity dependent audio parameter 128, a velocity dependent noise parameter 124, and an audio parameter adjustment 126. Profile data 130 may also be retained in memory 116.

The programs 122 may include a velocity dependent noise control program 132 and a velocity dependent audio control program 134. The velocity dependent noise control program 132 may determine a velocity dependent noise parameter 124 or an adjustment to a velocity dependent audio parameter 128 based on a vehicle velocity signal received from the navigation module 108, occupant inputs 118, and/or the microphone 120. The velocity dependent audio control program 134 may determine an audio parameter adjustment 126 based on a vehicle's speed calculated by or from data received from the navigation module 108. The audio parameter adjustment may also be based on a velocity dependent audio parameter 126 and/or a velocity dependent noise parameter 124.

The occupant inputs 118 may be used to receive profile data 128, select profile data 128, enter velocity dependent audio or noise data 128 and 124, and/or enter other functions into the velocity dependent audio module 104. In some systems, occupant inputs 118 also allow for an occupant to preset or manually adjust the velocity dependent audio or noise parameter 124 and 126. In other systems, the occupant inputs 118 also allow for the velocity dependent audio module to be turned on or off. The data entered with the occupant inputs 118 may be stored in memory 116 or other structures where information can be stored and received.

The microphone 120 may include one or more microphones. The microphone output may be monitored or polled to be used with the vehicle velocity data sent from the navigation module 108 to determine the velocity dependent noise parameter 126 and/or adjust the velocity dependent audio parameter 128.

The vehicle communication bus 102 interfaces the audio module 106, navigation module 108, velocity dependent audio module 104, and other vehicle modules 112. The audio module 106, navigation module 108, velocity dependent audio module 104, and other vehicle modules 112 may support one or many vehicle protocols. The bus interface 136 may use a pre-selected protocol, or may automatically detect and employ the protocol communicated on the bus 102. The vehicle communication bus 102 may be any type of vehicle bus, including a Class A, B, or C bus, any on-board diagnostic system (OBD) bus or protocol, Emissions/Diagnostics bus, Mobile Media bus, or X-by-Wire bus. The vehicle communication bus 102 may also include a Controller Area Network (CAN) bus, serial bus, Local Interconnect Network (LIN) bus, or Media Oriented Systems Transport (MOST).

The bus interface 136 includes interface circuitry and/or logic that couples the vehicle communication bus 102. The bus interface 136 may provide a unidirectional or bi-directional link between the audio module 106, navigation module 108, velocity dependent audio module 104, and other vehicle modules 112 over the vehicle communication bus 102. The audio module 106, navigation module 108, velocity dependent audio module 104, and other vehicle modules 112 may receive and/or transmit vehicle bus messages including commands, data, or both on the vehicle communication bus 102 to one more of the audio module 106, navigation module 108, velocity dependent audio module 104, and other vehicle modules 112.

The bus interface 136 may include a wireless transceiver, transmitter, and/or receiver. The wireless bus interface 136 may transmit and receive messages from the communication bus 102 without a wired connection. The bus interface 136 may employ any wireless communication protocol such as Bluetooth, wireless local area network (“WLAN”), wireless fidelity (“WiFi”), high performance radio local area network (“Hiper/LAN”), or other protocols.

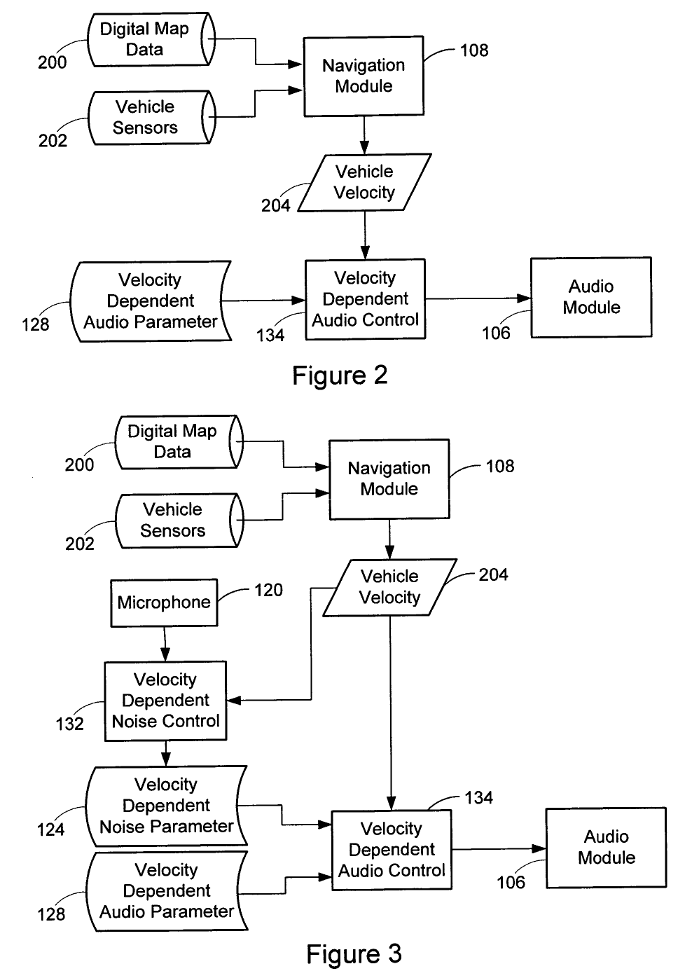

In FIG. 2, the navigation module 108 determines the vehicle velocity 204. Digital map data 200 and vehicle sensors 202 may assist the navigation module in measuring and/or calculating the vehicle velocity 204. The digital map data 200 may include geographical, weather, topographical, or other types of map data. The vehicle sensor(s) 202 may include a vehicle speed sensor, a wheel sensor, a gyroscope, or other sensor that measure or calculates velocity. The velocity sensors may have increased accuracy when calibrated with digital map data 200. A measured or calculated vehicle velocity may be the momentary, instantaneous, or current (e.g., measured or calculated in real time) vehicle velocity. The velocity dependent audio control 134 may determine an audio parameter adjustment for the audio module 106 using the vehicle velocity 204 and the velocity dependent audio parameter 128 inputs. The velocity dependent audio parameter 128 may comprise a ratio representing a desired volume at a given vehicle velocity 204. The velocity dependent audio parameter 128 may be manually or automatically determined. The audio parameter adjustment for the audio module 108 may be an adjustment to the volume, base, treble, equalizer settings, or other characteristics that may be perceived by the human ear.

In FIG. 3, the navigation module 108 determines the vehicle velocity 204 as described above. The vehicle velocity 204 may be input to the velocity dependent noise control program 132. The velocity dependent noise control program 132 may determine a velocity dependent noise parameter 124 based on the vehicle velocity 204 and one or more microphones 120. The velocity dependent noise parameter 124 may comprise a ratio representing the amount of noise detected or measured in the passenger compartment at a given vehicle velocity 204. The velocity dependent noise parameter 124 may be programmed within the vehicle system 100 during vehicle manufacture. Alternatively, the velocity dependent noise parameter 124 may be periodically or continuously determined or programmed while the vehicle is in use. Continuous determination of the velocity dependent noise parameter 124 may ensure the audio level is adapted to any momentary noise. In addition, the velocity dependent noise parameter 124 may be preset by an occupant using manual or electronic inputs.

The velocity dependent audio control program 134 determines an audio parameter adjustment 126 using one or more of the vehicle velocity 204, the velocity dependent audio parameter 128, and the velocity dependent noise parameter 124. The velocity dependent parameters 124 and 128 may be associated with profile data 130. The profile data 130 may contain presets for various external conditions, such as particular weather conditions or tire model size or other tire data. In addition, the profile data 130 may contain presets based on the subjective hearing perceptions of different vehicle occupants.

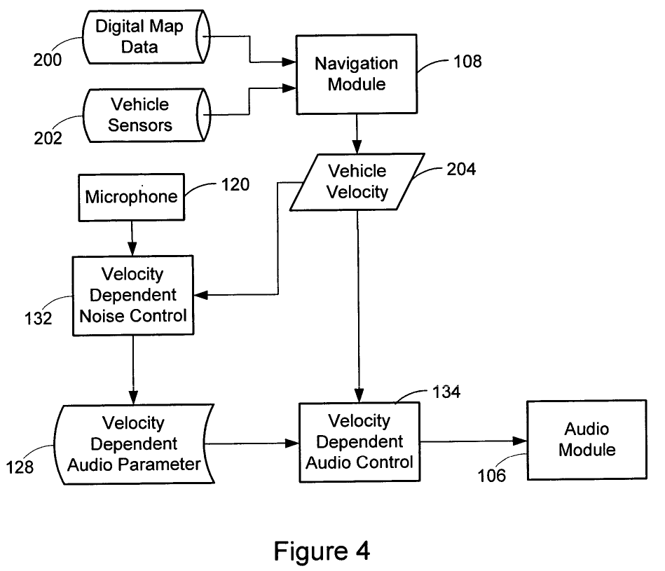

In FIG. 4, the navigation module 108 determines the vehicle velocity 204 as described above. The vehicle velocity 204 may be transmitted to the velocity dependent noise control program 132. The velocity dependent noise control program 132 may determine an adjustment to the velocity dependent audio parameter 128 based on the vehicle velocity 204 and output from the microphone 120. The velocity dependent audio parameter 124 may comprise a ratio factoring in the amount of noise at a given vehicle velocity, the user's audio preferences for a given vehicle velocity, and/or the current audio dependence for a given velocity. As described, the velocity dependent noise control program 132 may be programmed before or during vehicle manufacture, periodically while the vehicle is in use, or continuously while the vehicle is in use.

As described, the velocity dependent audio control program 134 may receive the velocity dependent audio parameter 128 and the vehicle velocity 204. The velocity dependent audio control program 134 determines an audio parameter adjustment to transmit to the audio module 106.

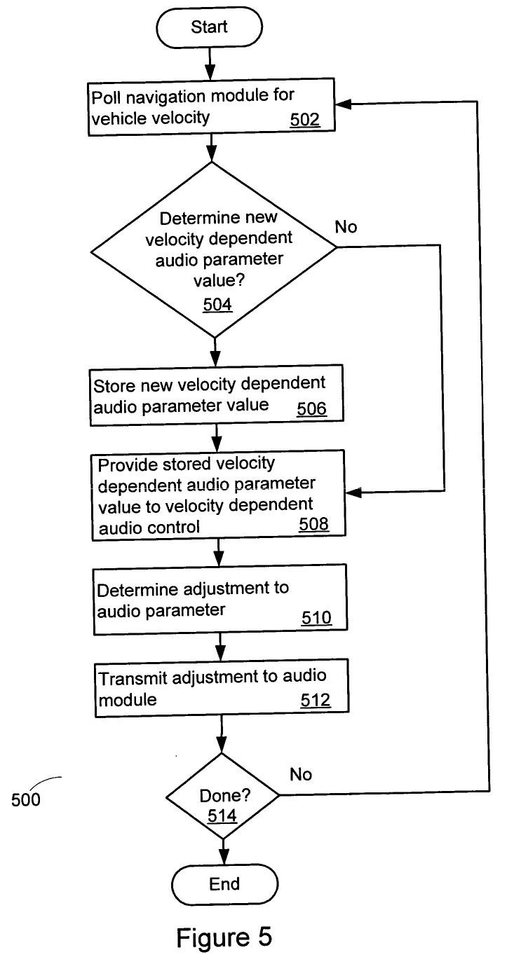

In FIG. 5, the audio adjustment may reside in the memory 116. The velocity dependent audio module 104 may request the vehicle velocity from the navigation module (Act 502). Alternatively or additionally, the velocity dependent audio module 104 may monitor or poll a bus carrying the vehicle velocity data 204. The process periodically determines the status of the device interfaced to the bus so that the velocity dependent audio module 204 can process the vehicle velocity data transmitted on the bus. The device may be accessed once or periodically at a user programmed interval.

A velocity dependent audio parameter value may be determined (Act 504). The velocity dependent audio parameter may be determined or previously described. Once the velocity dependent audio parameter value has been determined the value may be stored in a volatile, non-volatile, or block oriented (e.g., flash) memory (Act 506). Once stored the velocity dependent audio parameter value is received by the velocity dependent audio control (Act 508). The velocity dependent audio control program may determine an adjustment to the audio parameter (Act 510). The adjustment is transmitted to the audio module to be executed (Act 512). The velocity dependent audio module 104 may continue this process (Act 514) for a continuous or predetermined time.

The systems may operate through software programs run on a processor or controller. Dedicated hardware implementations including, but not limited to, application specific circuits, programmable logic arrays and other devices can likewise be constructed to implement these systems. Furthermore, alternative software implementations including, but not limited to, distributed processing or component/object distributed processing, parallel processing, or virtual machine processing can also be constructed to implement the described methods.

Some software implementations may be stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories; or a signal containing computer instructions being sent in a network environment. A digital file attachment to e-mail or other self-contained information archive or set of archives may be considered a distribution medium equivalent to a tangible storage medium. Accordingly, the system may include a tangible storage medium or distribution medium including art-recognized equivalents and successor media, in which the software implementations are stored.

Accordingly, the system may include a computer readable medium containing instructions, or that which receives and executes instructions from a propagated signal so that a device connected to a network environment can send or receive voice, video or data, and to communicate over the network using the instructions. The instructions form one or more routines that are executable to permit the device to operate in a desired manner.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A vehicle system comprising:
a navigation module that determines a vehicle velocity;
a memory that stores a velocity dependent audio control program and a velocity dependent audio parameter; and
a processor in communication with the navigation module and the memory that is operable to:
receive the vehicle velocity from the navigation module;
to determine an adjustment to an audio parameter using the velocity dependent audio control program, based on the vehicle velocity and the velocity dependent audio parameter; and
update the audio parameter based on the adjustment.

2. The vehicle system of claim 1, where the vehicle velocity is an instantaneous, momentary, or current vehicle velocity.

3. The vehicle system of claim 1, further comprising wheel sensors that interface the navigation module.

4. The vehicle system of claim 1, where the velocity dependent audio parameter comprises a manual control.

5. The vehicle system of claim 1, where the memory stores a velocity dependent noise control program, and the processor is further operable to update a second audio parameter based on the vehicle velocity and an output from a microphone.

6. The vehicle system of claim 5, where the processor is programmed to calculate the velocity dependent noise parameter at a single point in time, periodically in time, or continuously in time.

7. The vehicle system of claim 5, where the velocity dependent audio parameter is controlled automatically through the velocity dependent noise control program.

8. The vehicle system of claim 5, where the processor is further programmed to calculate the audio parameter adjustment based on the velocity dependent noise parameter.

9. The vehicle system of claim 5, where the velocity dependent noise parameter is manually preset by a user of the vehicle system.

10. The vehicle system of claim 1, where the velocity dependent audio parameter comprises profile data.

11. The vehicle system of claim 10, where the profile data comprises external condition data or data associated with the user occupant.

12. The vehicle system of claim 1, where a signal input controls whether the adjustment to the audio parameter occurs.

13. The vehicle system of claim 1, further comprising an audio module that receives and processes the adjustment to the audio parameter.

14. The vehicle system of claim 13, where the audio module comprises an entertainment and comfort device.

15. A method for updating an audio parameter to an audio module, the method comprising:
polling a navigation module for a vehicle velocity;
determining a velocity dependent audio parameter;
determining an adjustment to an audio parameter based on the vehicle velocity and the velocity dependent audio parameter; and
updating the audio parameter based on the adjustment.

16. The method of claim 15, where determining the velocity dependent audio parameter comprises:
polling a microphone for noise;
receiving the vehicle velocity;
determining an adjustment to the velocity dependent audio parameter based on the vehicle velocity and a detected noise; and
adjusting the velocity dependent audio parameter based on the velocity dependent audio parameter adjustment.

17. The method of claim 15, where determining the adjustment to the audio parameter is further based on a velocity dependent noise parameter.

18. The method of claim 17, where determining the velocity dependent noise parameter comprises:
polling a microphone to detect noise;
receiving the vehicle velocity; and
determining the velocity dependent noise parameter based on the vehicle velocity and a level of detected noise.

19. The method of claim 17, where the velocity dependent noise parameter is determined by a processor at a single point in time, periodically in time, or continuously in time.

20. The method of claim 17, where the velocity dependent noise parameter is manually preset by a user of the vehicle system.

21. The method of claim 15, where the vehicle velocity is an instantaneous, momentary, or current vehicle velocity.

22. The method of claim 15, where the navigation module interfaces wheel sensors and gyroscopes that provide data used to determine the vehicle velocity.

23. The method of claim 15, where the velocity dependent audio parameter is manually controlled.

24. The method of claim 15, where the velocity dependent audio parameter is associated with an external condition, an occupant, or profile data.

25. A vehicle system comprising:
a navigation device that determines a vehicle velocity;
a memory that stores a velocity dependent audio parameter; and
means for determining an audio parameter adjustment from the vehicle velocity and the velocity dependent audio parameter.

26. A velocity dependent audio module control product comprising:
a machine readable medium; and
instructions encoded on the machine readable medium, the instructions comprising:
instructions that map a navigation determined vehicle velocity to an adjustment to an audio parameter; and
modification instructions that adjust the audio parameter.
